(19) United States
(12) Patent Application Publication
(10) Pub. No.: US 2005/0048323 A1
(43) Pub. Date: Mar. 3, 2005

(54) Magnetic recording medium

(75) Inventor: Noboru Zinbo, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/897,096

(22) Filed: Jul. 23, 2004

(30) Foreign Application Priority Data
Jul. 23, 2003 (JP) P.2003-278531
Jul. 22, 2004 (JP) P.2004-214166

(51) Int. Cl. G11B 5/708; B32B 5/16

(52) U.S. Cl. 428/694 BH; 428/694 BS; 428/329; 428/694 BB

(57) ABSTRACT

A magnetic recording medium comprising a support and a magnetic layer containing a hexagonal ferrite powder and carbon black, the carbon black having a total content of Na⁺, K⁺Mg²⁺, Ca²⁺, and NH₄⁺ of 0 to 100 ppm and a total content of Cl⁻, No₂⁻, NO₃⁻, SO₄²⁻, and PO₄³⁻ of 0 to 100 ppm.

### FIELD OF THE INVENTION

This invention relates to a magnetic recording medium such as a magnetic tape and a magnetic disk, particularly a particulate magnetic recording medium of which the magnetic layer is formed by coating a non-magnetic support with a magnetic coating composition containing ferromagnetic powder and a binder as main components. More particularly, it relates to a magnetic recording medium excellent in low noise, high output and C/N in short wavelength writing and reading, storage stability, and running durability. The invention also relates to a magnetic recording medium capable of high-density recording and especially suited for a system using a magnetoresistive (MR) head in reading.

### BACKGROUND OF THE INVENTION

A particulate magnetic recording medium is composed of a non-magnetic support, such as a polyethylene terephthalate film, and a magnetic layer formed by coating the support with a magnetic coating composition having ferromagnetic powder dispersed in a binder resin solution. The ferromagnetic powder includes acicular powders, such as γ-Fe₂O₃, which have been used conventionally, and ultrafine hexagonal ferrite powders, which have recently been developed and come to be used practically in an attempt to achieve improved recording density.

In general, factors governing the behavior of magnetic powder dispersed in a binder resin solution include progress of agglomeration attributed, e.g., to magnetostatic interaction between magnetic powder particles and progress of dispersion ascribed to interfacial chemical interaction between the magnetic powder surface and the binder solution. It is considered that the interfacial chemical interaction between a binder solution and the powder surface occurs in proportion with the powder's surface area. The latest trend to a high packing density boosted the demand for finer ferromagnetic powder, which has made it more and more difficult to disperse ferromagnetic powder.

Fine hexagonal ferrite powder as magnetic powder has been said to be difficult to disperse and maintain in a dispersed state. This is because, for one thing, the powder particles are tabular and therefore exert larger magnetic interaction and, for another, the individual particles are single crystals, which hardly show a microstructure with, for example, a finely textured surface as observed with conventional acicular particles, which are polycrystalline aggregates. Hence, particulate magnetic recording media using hexagonal ferrite powder often lack surface precision adequate to high density recording. To address this problem, coating hexagonal ferrite particles with an organic substance has been suggested but yielded no sufficient results. A combination of kneading treatment and dispersion in a sand mill, etc. has also been attempted, but there is a limit in improvements achievable on dispersibility, coating film strength, and coating film smoothness.

According as the demands for smaller equipment, higher quality of reproduced signals, longer recording time, increased recording capacity, and the like have been realized, magnetic recording media have now come to be used in very varied environments and are required to have equal running stability between when used and stored under severe environmental conditions and when used under ordinary conditions.

A magnetic recording medium having, on its support, at least two layers including a non-magnetic lower layer containing non-magnetic powder and a binder and a magnetic upper layer containing hexagonal ferrite powder and a binder shows, in principle, reduced self demagnetization and has a reduced surface roughness (reduced spacing loss) and therefore exhibits high performance. Nevertheless, a magnetic recording medium having a hexagonal ferrite-containing magnetic layer has turned out to have the following disadvantage when run after storage in high temperature and high humidity conditions. The medium shows an increased frictional coefficient and suffers from abrasion, which causes contamination of guide poles and the head. It follows that the dropout rate (DO) and the missing pulse rate (MP) increase. In extreme cases the medium can stick to the head, etc. and stop running.

The above-mentioned problem possessed by a magnetic recording medium having a magnetic layer containing conventional hexagonal ferrite powder is attributable to change in surface characteristics caused by impurities originated in the hexagonal ferrite powder, etc. or formation of salts of such impurities. From this viewpoint, attempts have been made to limit the water-soluble anion content of a hexagonal ferrite powder to be used as reported, e.g., in JP-A-2003-59030. However, the technique of JP-A-2003-59030 is still insufficient in storage stability, running durability, and electromagnetic characteristics, leaving the room for further improvements.

### SUMMARY OF THE INVENTION

An object of the present invention is to provide a particulate magnetic recording medium with improved performance in storage stability, running durability, and electromagnetic characteristics.

The present invention provides a magnetic recording medium having a support and a magnetic layer provided on the support, the magnetic layer containing a hexagonal ferrite powder and carbon black. The carbon black has a total water-soluble cation content of 0 to 100 ppm (preferably 0 to 80 ppm, and more preferably 0 to 60 ppm), and a total water-soluble anion content of 0 to 100 ppm (preferably 0 to 80 ppm, and more preferably 0 to 60 ppm). The water-soluble cations are Na⁺, K⁺, Mg²⁺, Ca²⁺, and NH₄⁺. The water-soluble anions are Cl⁻, No₂⁻, NO₃⁻, SO₄²⁻, and PO₄³⁻. The magnetic recording medium of the invention exhibits improved performance in storage stability, running durability, and electromagnetic characteristics.

Although the mechanism of action according to the present invention is not necessarily clear, the following assumption can be made. Because hexagonal ferrite powder has a relatively high surface resistivity, there has been a fear that a magnetic recording medium having a hexagonal ferrite-containing magnetic layer is liable to attract dust, which can cause dropouts, head contamination, head clogging, and MR head corrosion. Incorporation of carbon black into the hexagonal ferrite-containing magnetic layer reduces the surface resistivity of the layer and therefore reduces the problems due to dust attraction. To use not impure but high purity carbon black suppresses salt precipitation in high temperature and high humidity conditions thereby improving storage stability.

Containing carbon black having limited water-soluble cation and water-soluble anion contents, the magnetic recording medium of the present invention has a stable coefficient of friction and suffers from little precipitation on its surface even when stored under high temperature and high humidity conditions and therefore exhibits improved storage stability and improved running durability. Besides, the magnetic recording medium of the invention is satisfactory in electromagnetic performance including low noise for a high C/N ratio.

### DETAILED DESCRIPTION OF THE INVENTION

The magnetic layer of the magnetic recording medium of the invention contains a hexagonal ferrite powder and carbon black. The carbon black, the most characteristic element constituting the invention, will be described first.

The carbon black used in the magnetic layer is specified in terms of amounts of specific water-soluble cations and specific water-soluble anions released therefrom.

The water-soluble cation content (ppm) of carbon black is a total mass of Na⁺, K⁺, Mg²⁺, Ca²⁺, and NH₄⁺ per unit mass of carbon black powder measured by stirring 5 g of carbon black powder in 100 ml of distilled water for 1 hour, filtering the supernatant liquid, and analyzing the filtrate by ICP-OES (inductive coupled plasma optical emission spectroscopy). The water-soluble cation content can also be measured by atomic absorption spectroscopy, ion chromatography, or an appropriate combination of the recited analyses.

The water-soluble anion content (ppm) of carbon black is a total mass of Cl⁻, NO₂⁻, NO₃⁻, SO₄²⁻, and PO₄³⁻ per unit mass of carbon black powder measured by stirring 5 g of carbon black powder in 100 ml of distilled water for 1 hour, filtering the supernatant liquid, and analyzing the filtrate by ion chromatography (IC)).

Means for controlling the water-soluble cation and water-soluble anion contents each within 100 ppm basically includes, but is not limited to, (i) selecting a raw material containing no or little impurity of the elements, (ii) adding the step of removing (e.g., washing away) the elements incorporated into any reaction system in the preparation of carbon black powder, and (iii) adopting such a reaction system that does not involve generation of the elements.

Used in the magnetic layer, the carbon black powder with so controlled water-soluble cation and anion contents inhibits formation of metal salts, aliphatic acid salts, etc. and provides a magnetic recording medium with excellent storage stability without impairing electromagnetic characteristics such as output and C/N.

As long as the contents of the specific water-soluble cations and the specific water-soluble anions are within the recited ranges, the carbon black to be used in the invention is not particularly restricted in kind. Usable kinds include furnace black for rubber products, thermal black for rubber products, carbon black for colors, and acetylene black. It is preferred to use carbon black having a BET specific surface area (S_{BET}) of 5 to 500 m²/g, a DBP (dibutyl phthalate) oil absorption of 10 to 400 ml/100 g, an average particle size of 5 to 300 nm, a pH of 2 to 10, a water content of 0.1 to 10%, and a tap density of 0.1 to 1 g/cc. Specific examples of suitable carbon black species include those enumerated in WO 98/35345.

Carbon black also serves for static prevention, friction reduction, light shielding, and film strength enhancement in favor of the magnetic layer. These actions vary between kinds. Accordingly, where the magnetic recording medium has a multi-layered structure, it is possible or rather advisable to optimize the kind, amount or combination of kinds of carbon black for each layer taking into consideration the particle size, oil absorption, electrical conductivity, pH or like characteristics.

While the ferromagnetic hexagonal ferrite powder that can be used in the magnetic layer is not particularly restricted, examples include M-type magnetoplumbite hexaferrites in which iron and a metal substituting iron have a valence of 3 in average, typified by BaFe₁₂O₁₉; W-type magnetoplumbite hexaferrites containing divalent metal (hereinafter represented by M), typified by BaM₂Fe₁₆O₂₇; Y-type magnetoplumbite hexaferrites typified by BaMFe₆O₁₁; Z-type magnetoplumbite hexaferrites typified by Ba3M₂Fe₂₄O₄₁; and complex type ferrites having spinel-type ferrite epitaxially grown on these hexaferrites.

The metals represented by M in the compositional formulae shown above and the divalent metal making up the spinel-type ferrites include Co, Fe, Ni, Mn, Mg, Cu, and Zn.

The hexagonal ferrite preferably has an average length (defined later) of 10 to 35 nm. An average length of at least 10 nm assures sufficient magnetization for use in a recording medium. With the average length being 35 nm or shorter, the noise component is reduced in favor of high-density recording.

The hexagonal ferrite powder preferably has a coefficient of length variation of 30% or smaller, still preferably 28% or smaller. The coefficient of length variation is calculated from σ/averaqe length×100, where σ is a standard deviation of length. The coefficient of thickness variation is preferably 30% or smaller, still preferably 26% or smaller.

The hexagonal ferrite powder preferably has an average aspect ratio (arithmetic average of length to thickness ratio) of 2 to 5. Hexagonal ferrite powder with an average aspect ratio smaller than 2 is difficult to produce. Hexagonal ferrite powder with an average aspect ratio greater than 5 exhibits magnetically attractive force predominantly over dispersive force and is difficult to disperse. The coefficient of variation of the aspect ratio is preferably 30% or smaller.

The particle size of various powders used in the invention including the hexagonal ferrite powder and carbon black is measured from high-resolution transmission electron micrographs with the aid of an image analyzer. The outline of particles on micrographs is traced with the image analyzer to obtain the particle size. The particle size is represented by (1) the length of a major axis where a particle is needle-shaped, spindle-shaped or columnar (with the height greater than the maximum diameter of the base), (2) a maximum length of a main plane or a base where a particle is tabular or columnar (with the height smaller than the maximum length of the base), or (3) a circle equivalent diameter where a particle is spherical, polygonal or amorphous and has no specific major axis.

The average particle size of powder is an arithmetic mean calculated from the particle sizes of about 500 particles measured as described above.

The term “average particle size” as used herein refers to the “average major axis length” of particles having the shape identified in (1) above; the “average length” of particles having the shape identified in (2); or the “average circle equivalent diameter” of particles having the shape identified in (3). The average aspect ratio of powder is an arithmetic mean of major axis length/minor axis length ratios of particles defined in (1) above or an arithmetic mean of length/thickness ratios of particles defined in (2) above. The term “minor axis length” as used herein means the maximum length of axes perpendicular to the major axis of a particle defined in (1) above. In the case of the particles defined in (3) above, the aspect ratio is regarded as 1 for the sake of convenience.

The hexagonal ferrite powder to be used in the invention can be prepared by any process, such as a process by controlled crystallization of glass, a hydrothermal process, a coprecipitation process, or a flux process. A hydrothermal process is preferred. Whichever process is followed, it is important for achieving a high packing density to find out conditions providing sharp distribution in both shape and size.

The hexagonal ferrite powder preferably has a saturation magnetization σs of 40 to 80 A·m²/kg, still preferably 45 to 70 A·m²/kg; a coercive force Hc of 1700 to 5000 Oe (136 to 400 kA/m), still preferably 170 to 3500 Oe (136 to 280 kA/m), and an S_{BET} of 40 to 120 g/m², still preferably 45 to 110 g/m². The pH of the magnetic powder is desirably optimized according to the binder used in combination. It is usually 4 to 12, preferably 5.5 to 10.

It is preferred for the hexagonal ferrite powder, too, to have a water-soluble cation content (a total of Na⁺, K⁺, Mg²⁺, Ca²⁺, and NH₄⁺) of 0 to 100 ppm (preferably 0 to 80 ppm, and more preferably 0 to 60 ppm) and a water-soluble anion content (a total of Cl⁻, No₂⁻, NO₃⁻, SO₄²⁻, and PO₄³⁻) of 0 to 100 ppm (preferably 0 to 80 ppm, and more preferably 0 to 60 ppm).

The water-soluble anion content and the water-soluble cation content of the hexagonal ferrite powder can be measured in the same manner as for the carbon black powder, except for replacing a carbon black sample with a hexagonal ferrite sample.

Means for controlling the water-soluble cation and water-soluble anion contents of the hexagonal ferrite powder basically includes, but is not limited to, (i) selecting a raw material containing no or little impurity of the elements, (ii) adding the step of removing (e.g., washing away) the elements incorporated in any reaction system in the preparation of hexagonal ferrite powder, and (iii) adopting such a reaction system that does not involve generation of the elements.

With so controlled water-soluble cation and anion contents, the hexagonal ferrite powder contributes to further inhibition of formation of metal salts, aliphatic acid salts, etc. and provides a magnetic recording medium with further improved performance in storage stability and electromagnetic characteristics such as output and C/N.

It is desirable for the hexagonal ferrite powder not to form a benzohydroxamic acid iron complex of more than 10 ppm. The amount of the iron complex formed by hexagonal ferrite powder is measured as follows. Two grams of hexagonal ferrite powder is immersed in 50 ml of a 0.05 mol/l ethanol solution of purified benzohydroxamic acid and maintained at 25° C. for 20 hours, followed by filtration. The absorbance of the filtrate is measured to know the concentration of the benzohydroxamic acid iron complex in the solution from a previously prepared calibration curve. The mass of iron ions of the complex formed per gram of the hexagonal ferrite powder is calculated.

Means for controlling formation of the iron complex within the range of from 0 to 10 ppm includes, but is not limited to, coating the hexagonal ferrite particles with a hydrated alumina layer or a combination of a hydrated alumina layer and a zinc oxide layer or treating the hexagonal ferrite particles with an adsorbent substance having a pKa of 4.0 or smaller or a salt thereof. By controlling the formation of the iron complex within the recited range, the effects of the present invention are enhanced.

The magnetic recording medium of the invention includes a single-sided one and a double-sided one.

The magnetic layer provided on at least one side of a support may have either a single layer structure or a multilayered structure composed of two or more layers different in composition. The magnetic recording medium may have a non-magnetic layer between the support and the magnetic layer. The non-magnetic layer will hereinafter be sometimes referred to as a lower layer. The magnetic recording medium of the invention preferably has a dual layer structure having such a lower non-magnetic layer and an upper magnetic layer. The upper magnetic layer in the dual layer structure will hereinafter be sometimes referred to as an upper layer.

The lower and upper layers can be formed by simultaneous or successive wet-on-wet application, or the upper layer may be formed by wet-on-dry application. Wet-on-wet application is preferred for productivity. Moreover, the wet-on-wet application method, which forms the lower and upper layers almost at a time, allows effective use of a surface finishing step such as calendering, to provide an upper layer that is thin and yet has improved surface properties.

The lower layer preferably contains non-magnetic inorganic powder and a binder as main components. The non-magnetic inorganic powder used in the lower layer is selected from inorganic compounds, such as metal oxides, metal carbonates, metal nitrides, metal carbides, and metal sulfides. Examples of the inorganic compounds are α-alumina (with an α-phase content of at least 90%), β-alumina, γ-alumina, θ-alumina, silicon carbide, chromium oxide, cerium oxide, α-iron oxide, hematite, goethite, corundum, silicon nitride, titanium carbide, titanium dioxide, silicon dioxide, tin oxide, magnesium oxide, tungsten oxide, zirconium oxide, boron nitride, zinc oxide, calcium carbonate, calcium sulfate, barium sulfate, and molybdenum disulfide. They can be used either individually or in combination. Preferred among them are titanium dioxide, zinc oxide, iron oxide, and barium sulfate, particularly titanium dioxide and alpha iron oxide, because they can be produced with narrow particle size distribution and be endowed with a desired function through many means.

The non-magnetic inorganic powder preferably has an average particle size of 0.005 to 2 μm. If desired, non-magnetic powders different in average particle size may be used in combination, or a single kind of a non-magnetic powder having a broadened size distribution may be used to produce the same effect. A still preferred particle size of the non-magnetic powder is 0.01 to 0.2 μm. In particular, a particulate metal oxide powder preferably has an average particle size of 0.08 μm or smaller, and a needle-like metal oxide powder preferably has a length (major axis length) of 0.3 μm or shorter, especially, 0.2 μm or shorter. The tap density of the powder is 0.05 to 2 g/ml, preferably 0.2 to 1.5 g/ml. The water content of the non-magnetic powder is 0.1 to 5% by weight, preferably 0.2 to 3% by weight, still preferably 0.3 to 1.5% by weight. The non-magnetic powder usually has a pH of 2 to 11, preferably between 5.5 and 10, still preferably between 3 and 6, and a S_{BET} of 1 to 100 m²/g, preferably 5 to 80 m²/g, still preferably 10 to 70 m²/g. The non-magnetic powder preferably has a crystallite size of 0.004 to 1 μm, still preferably 0.04 to 0.1 μm. The DBP oil absorption is usually 5 to 100 ml/100 g, preferably 10 to 80 ml/100 g, still preferably 20 to 60 ml/100 g. The specific gravity is usually 1 to 12, preferably 3 to 6. The particle shape may be any of needle-like, spherical, polygonal and tabular shapes. The Mohs hardness is preferably 4 to 10. The SA (stearic acid) adsorption of the non-magnetic powder is in a range of 1 to 20 μmol/m², preferably 2 to 15 μmol/m², still preferably 3 to 8 μmol/m².

It is preferred that Al₂O₃, SiO₂, TiO₂, ZrO₂, SnO₂, Sb₂O₃, ZnO or Y₂O₃ be present on the surface of the non-magnetic inorganic powder by surface treatment. Among them, preferred for dispersibility are Al₂O₃, SiO₂, TiO₂, and ZrO₂, with Al₂O₃, SiO₂, and ZrO₂ being still preferred. These oxides may be used either individually or in combination. According to the purpose, a composite surface layer can be formed by co-precipitation or a method comprising first applying alumina to the non-magnetic particles and then treating with silica or vise versa. The surface layer may be porous for some purposes, but a homogeneous and dense surface layer is usually preferred.

Specific examples of the non-magnetic inorganic powders that can be used in the lower layer and methods of preparing the non-magnetic inorganic powders are disclosed in WO 98/35345.

Carbon black can be incorporated into the lower layer to produce known effects, i.e., reduction of surface resistivity and reduction of light transmission, and also to obtain a desired micro Vickers hardness. Addition of carbon black to the lower layer is also effective in holding a lubricant. Useful carbon black species include furnace black for rubber, thermal black for rubber, carbon black for colors, and acetylene black. The characteristics of carbon black to be used, such as those described below, should be optimized according to an intended effect. Combined use of different kinds of carbon black can bring about enhancement of the effect.

The carbon black in the lower layer usually has an S_{BET} of 100 to 500 m²/g, preferably 150 to 400 m²/g; a DBP oil absorption of 20 to 400 ml/100 g, preferably 30 to 400 ml/100 g; and an average particle size of 5 to 80 nm, preferably 10 to 50 nm, still preferably 10 to 40 nm. The carbon black may contain particles greater than 80 nm in a small proportion. The carbon black preferably has a pH of 2 to 10, a water content of 0.1 to 10% by weight, and a tap density of 0.1 to 1 g/ml.

Specific examples of carbon black species that can be used in the lower layer include those described in WO 98/35345. The carbon black is used in an amount of 50% by weight or less based on the non-magnetic inorganic powder (exclusive of carbon black) and 40% by weight or less based on the weight of the non-magnetic lower layer. The carbon black species can be used either individually or as a combination thereof. In selecting carbon black species for use in the present invention, reference can be made, e.g., in Carbon Black Kyokai (ed.), Carbon Black Binran.

The lower layer can contain organic powder according to the purpose. Useful organic powders include acrylic-styrene resin powders, benzoquanamine resin powders, melamine resin powders, and phthalocyanine pigments. Polyolefin resin powders, polyester resin powders, polyamide resin powders, polyimide resin powders, and polyethylene fluoride resin powders are also usable. Methods of preparing these resin powders include those disclosed in JP-A-62-18564 and JP-A-60-255827.

With respect to the other techniques involved in forming the lower layer and a backcoating layer (described later), e.g., binder resins, lubricants, dispersants, additives, solvents, and methods of dispersion, the following description as for the magnetic layer applies. In particular, known techniques regarding a magnetic layer can be applied with respect to the kinds and amounts of binder resins, additives and dispersants.

Binders that can be used in the present invention include conventionally known thermoplastic resins, thermosetting resins and reactive resins, and mixtures thereof. The thermoplastic resins used as a binder usually have a glass transition temperature of −100 to 150° C., an number average molecular weight of 1,000 to 200,000, preferably 10,000 to 100,000, and a degree of polymerization of about 50 to 1000.

Such thermoplastic resins include homo- or copolymers containing a unit derived from vinyl chloride, vinyl acetate, vinyl alcohol, maleic acid, acrylic acid, an acrylic ester, vinylidene chloride, acrylonitrile, methacrylic acid, a methacrylic ester, styrene, butadiene, ethylene, vinyl butyral, vinyl acetal, a vinyl ether, etc.; polyurethane resins, and various rubber resins. Useful thermosetting or reactive resins include phenolic resins, epoxy resins, thermosetting polyurethane resins, urea resins, melamine resins, alkyd resins, reactive acrylic resins, formaldehyde resins, silicone resins, epoxy-polyamide resins, polyester resin/isocyanate prepolymer mixtures, polyester polyol/polyisocyanate mixtures, and polyurethane/polyisocyanate mixtures. For the details of these resins, Plastic Handbook, Asakura Shoten (publisher) can be referred to. Known electron beam (EB)-curing resins can also be used in each layer. The details of the EB-curing resins and methods of producing them are described in JP-A-62-256219. The above-recited resins can be used either individually or as a combination thereof. Preferred resins are a combination of a polyurethane resin and at least one vinyl chloride resin selected from polyvinyl chloride, a vinyl chloride-vinyl acetate copolymer, a vinyl chloride-vinyl acetate-vinyl alcohol copolymer, and a vinyl chloride-vinyl acetate-maleic anhydride copolymer and a combination of the above-described combination and polyisocyanate.

The polyurethane resin includes those of known structures, such as polyester polyurethane, polyether polyurethane, polyether polyester polyurethane, polycarbonate polyurethane, polyester polycarbonate polyurethane, and polycaprolactone polyurethane.

In order to ensure dispersing capabilities and durability, it is preferred to introduce into each of the polyurethane resins at least one polar group by copolymerization or through addition reaction, the polar group being selected from —COOM, —SO₃M, —OSO₃M, —P═O(OM)₂, —O—P═O(OM)₂ (wherein M is a hydrogen atom or an alkali metal base), —NR₂, —N⁺R₃ (wherein R is a hydrocarbon group), an epoxy group, —SH, —CN, and the like. The amount of the polar group to be introduced is 10⁻¹ to 10⁻⁸ mol/g, preferably 10⁻² to 10⁻⁶ mol/g. The polyurethane resins preferably contain at least one hydroxyl group at each terminal thereof in addition to the polar group. Because a hydroxyl group reacts with a polyisocyanate curing agent to form a three dimensional network structure, the number of hydroxyl groups per molecule is preferably as large as possible. The hydroxyl group is particularly reactive with the curing agent when present in the molecular terminals. The number of hydroxyl groups present in the terminals of polyurethane molecule is preferably 3 or greater, still preferably 4 or greater. The polyurethane to be used preferably has a glass transition temperature of −50° to 150° C., preferably 0° to 100° C., still preferably 30° to 100° C., an elongation at break of 10 to 2000%, a stress at rupture of 0.05 to 10 kg/mm² (≈0.49 to 98 Mpa), and a yield point of 0.05 to 10 kg/mm² (≈0.49 to 98 Mpa). By using a polyurethane resin binder having these physical properties provides a coating film with satisfactory mechanical characteristics.

Examples of commercially available vinyl chloride copolymers that can be used as a binder are VAGE, VYHH, VMCH, VAGF, VAGD, VROH, VYES, VYNC, VMCC, XYHL, XYSG, PKHH, PKHJ, PKHC, and PKFE (from Union Carbide Corp.); MPR-TA, MPR-TA5, MPR-TAL, MPR-TSN, MPR-TMF, MPR-TS, MPR-TM, and MPR-TAO (from Nisshin Chemical Industry Co., Ltd.); 1000w, DX80, DX81, DX82, DX83, and 100FD (from Denki Kagaku Kogyo K.K.); and MR-104, MR-105, MR110, MR100, MR555, and 400X-110A (from Zeon Corp.). Examples of commercially available polyurethane resins that can be used as a binder are Nipporan N2301, N2302, and N2304 (from Nippon Polyurethane Industry Co., Ltd.); Pandex T-5105, T-R3080, and T-5201, Barnock D-400 and D-210-80, and Crisvon 6109 and 7209 (from Dainippon Ink & Chemicals, Inc.); Vylon UR8200, UR8300, UR-8700, RV530, and RV280 (from Toyobo Co., Ltd.); Daiferamin 4020, 5020, 5100, 5300, 9020, 9022, and 7020 (from Dainichiseika Color & Chemicals Mfg. Co., Ltd.); MX5004 (from Mitsubishi Chemical Corp.); Sanprene SP-150 (from Sanyo Chemical Industries, Ltd.); and Saran F310 and F210 (from Asahi Chemical Industry Co., Ltd.).

The binder is used in the non-magnetic layer and the magnetic layer in an amount of 5 to 50% by weight, preferably 10 to 30% by weight, based on the non-magnetic inorganic powder and the hexagonal ferrite powder, respectively. Where a vinyl chloride resin, a polyurethane resin, and polyisocyanate are used in combination, their amounts are selected from a range of 5 to 30% by weight, a range of 2 to 20% by weight, and a range of 2 to 20% by weight, respectively. In case where head corrosion by a trace amount of released chlorine is expected to occur, polyurethane alone or a combination of polyurethane and polyisocyanate can be used.

When the magnetic recording medium has a multilayered structure, the constituent layers can have different binder formulations in terms of the binder content, the proportions of a vinyl chloride resin, a polyurethane resin, polyisocyanate, and other resins, the molecular weight of each resin, the amount of the polar group introduced, and other physical properties of the resins. It is rather desirable to optimize the binder design for each layer. For the optimization, known techniques relating to a non-magnetic/magnetic multilayer structure can be utilized. For example, to increase the binder content of the magnetic layer is effective to reduce scratches on the magnetic layer, or to increase the binder content of the non-magnetic layer is effective to increase flexibility thereby to improve head touch.

The polyisocyanate that can be used in the invention includes tolylene diisocyanate, 4,4′-diphenylmethane diisocyanate, hexamethylene diisocyanate, xylylene diisocyanate, naphthylene-1,5-diisocyanate, o-toluidine diisocyanate, isophorone diisoyanate, and triphenylmethane triisocyanate. Further included are reaction products between these isocyanate compounds and polyols and polyisocyanates produced by condensation of the isocyanates. Examples of commercially available polyisocyanates which can be used in the invention are Coronate L, Coronate HL, Coronate 2030, Coronate 2031, Millionate MR, and Millionate MTL (from Nippon Polyurethane Industry Co., Ltd.); Takenate D-102, Takenate D-110N, Takenate D-200, and Takenate D-202 (from Takeda Chemical Industries, Ltd.); and Desmodur L, Desmodur IL, Desmodur N, and Desmodur HL (from Sumitomo Bayer Urethane Co., Ltd.). They can be used in each layer, either alone or as a combination of two or more thereof taking advantage of difference in curing reactivity.

Known abrasives mostly having a Mohs hardness of 6 or higher can be used in the present invention. Such abrasives include α-alumina having an α-phase content of at least 90%, β-alumina, silicon carbide, chromium oxide, cerium oxide, α-iron oxide, corundum, artificial diamond, silicon nitride, titanium carbide, titanium oxide, silicon dioxide, and boron nitride. These abrasives can be used either individually or as a mixture thereof or as a composite thereof (an abrasive surface treated with another). Existence of impurity compounds or elements, which are sometimes observed in the abrasives, will not affect the effect as long as the content of the main component is 90% by weight or higher. The abrasives preferably have an average particle size of 0.01 to 2 μm. In order to improve electromagnetic characteristics, in particular, it is desirable for the abrasives to have a narrow size distribution. In order to improve durability, abrasives different in particle size may be used in combination, or a single kind of an abrasive having a broadened size distribution may be used to produce the same effect. The abrasives preferably have a tap density of 0.3 to 2 g/ml, a water content of 0.1 to 5% by weight, a pH of 2 to 11, and an S_{BET} of 1 to 30 m²/g. The abrasive grains may be needle-like, spherical or cubic. Angular grains are preferred for high abrasive performance. Specific examples of suitable abrasives are described in WO 98/35345. Inter alia, diamond as used in the manner described in WO 98/35345 is effective in improving running durability and electromagnetic characteristics. As is understandable, the particle size and amount of the abrasives used in the magnetic and non-magnetic layers should be optimized.

Other additives that can be used in the magnetic layer and the non-magnetic layer include those producing lubricating effects, antistatic effects, dispersing effects, plasticizing effects, and the like. Additives with such effects can be used in appropriate combination to bring about well-balanced improvements on performance. Additives with lubricating effects are lubricants capable of reducing adhesion between two surfaces in a frictional contact. Lubrication mechanism is divided into a fluid lubrication mode and a boundary lubrication mode. Although it is difficult to definitely judge which mode of lubrication a lubricant exhibits, the lubricants used in magnetic recording media are classified according to general concept of lubrication into those exhibiting fluid lubrication, such as higher fatty acid esters, liquid paraffin, and silicone derivative, and those of boundary lubrication, such as long-chain fatty acids, fluorine-containing surface active agents, and fluoropolymers. In a particulate magnetic recording medium, a lubricant exists mostly in a dissolved state in the binder and partly in an adsorbed state onto the surface of the hexagonal ferrite powder and gradually migrates to the magnetic layer surface. The migration speed depends on the compatibility between the binder and the lubricant. A lubricant less compatible with a binder migrates faster and vice versa. Comparison of solubility parameters of a binder and a lubricant is among approaches for evaluating compatibility between them. Non-polar lubricants are effective for fluid lubrication, while polar ones are effective for boundary lubrication.

In the present invention it is preferred to use a combination of a higher fatty acid ester exhibiting fluid lubrication and a long-chain fatty acid exhibiting boundary lubrication. It is particularly desirable to combine at least three kinds of these lubricants. A solid lubricant may also be used together with the combined lubrication system. Useful solid lubricants include molybdenum disulfide, tungsten disulfide, graphite, boron nitride, and graphite fluoride. The long-chain fatty acids used for boundary lubrication include monobasic fatty acids having 10 to 24 carbon atoms, which may be saturated or unsaturated and straight-chain or branched, and their metal (e.g., Li, Na, K, Cu) salts. The fluorine-containing surface active agents and fluoropolymers, which are also categorized into lubricants showing boundary lubrication, include F-containing silicones, F-containing alcohols, F-containing esters, and F-containing alkylsulfuric esters and alkali metal salts thereof. The higher fatty acid esters used for fluid lubrication include mono-, di- or tri-fatty acid esters between monobasic fatty acids having 10 to 24 carbon atoms, which may be saturated or unsaturated and straight-chain or branched, and at least one of mono- to hexahydric, saturated or unsaturated, and straight-chain or branched alcohols having 2 to 12 carbon atoms and fatty acid esters of polyalkylene oxide monoalkyl ethers. The liquid paraffin and the silicone derivatives, which are also categorized into lubricants showing fluid lubrication, include silicone oils, such as dialkylpolysiloxanes having 1 to 5 carbon atoms in the alkyl moiety thereof, dialkoxypolysiloxanes having 1 to 4 carbon atoms in the alkoxy moiety thereof, monoalkylmonoalkoxypolysiloxanes having 1 to 5 carbon atoms in the alkyl moiety and 1 to 4 carbon atoms in the alkoxy moiety thereof, phenylpolysiloxanes, and fluoroalkylpolysiloxanes having 1 to 5 carbon atoms in the alkyl moiety thereof; polar group-containing silicones, fatty acid-modified silicones, and fluorine-containing silicones.

Also included in usable lubricants are alcohols, such as mono- to hexahydric, saturated or unsaturated, and straight-chain or branched alcohols having 12 to 22 carbon atoms, saturated or unsaturated and straight-chain or branched alkoxyalcohols having 12 to 22 carbon atoms, fluorine-containing alcohols; polyolefins, such as polyethylene wax and polypropylene; polyglycols, such as ethylene glycol and polyethylene oxide wax; alkylphosphoric esters and alkali metal salts thereof; alkylsulfuric esters and alkali metal salts thereof; polyphenyl ethers; fatty acid amides having 8 to 22 carbon atoms; and aliphatic amines having 8 to 22 carbon atoms.

Additives showing antistatic effect, dispersing effect, plasticizing effect, and the like include phenylphosphonic acid (e.g., PPA available from Nissan Chemical Industries, Ltd.), α-naphthylphosphoric acid, phenylphosphoric acid, diphenylphosphoric acid, p-ethylbenzenephosphonic acid, phenylphosphinic acid, aminoquinones, silane coupling agents, titan coupling agents, and fluorine-containing alkylsulfuric esters and alkali metal salts thereof.

Fatty acids and fatty acid esters are preferred lubricants for use in the invention. Specific examples of these lubricants include those recited in WO 98/35345. These lubricants can be used in combination with other lubricants and other additives. A combined use of a fatty acid monoester and a fatty acid diester as taught in WO 98/35345 is a preferred lubricant formulation.

The magnetic and non-magnetic layers can contain surface active agents. Useful surface active agents include nonionic ones, such as alkylene oxide types, glycerol types, glycidol types, and alkylphenol ethylene oxide adducts; cationic ones, such as cyclic amines, ester amides, quaternary ammonium salts, hydantoin derivatives, heterocyclic compounds, phosphonium salts, and sulfonium salts; anionic ones containing an acidic group, such as a carboxyl group, a sulfonic acid group, a phosphoric acid group, a sulfuric ester group or a phoshoric ester group; and amphoteric ones, such as amino acids, aminosulfonic acids, amino alcohol sulfuric or phosphoric esters, and alkyl betaines. For the details of the surface active agents, refer to Kaimen Kasseizai Binran published by Sangyo Tosho K.K.

The above-recited lubricants, antistatic agents, and like additives do not always need to be 100% pure and may contain impurities, such as isomers, unreacted materials, by-products, decomposition products, and oxides. The proportion of the impurities is preferably 30% by weight at the most, still preferably 10% by weight or less.

The magnetic layer surface of the magnetic recording medium, especially a magnetic recording disk, of the present invention preferably has a C/Fe peak ratio of 5 to 100, still preferably 5 to 80, as analyzed by Auger electron spectroscopy (AES). AES is carried out under the following conditions: Equipment: PHI 660 scanning Auger microprobe, manufactured by PHI Inc.
Primary accelerating voltage: 3 kv
Sample current: 130 nA
Magnification: 250 times
Tilt angle: 30°

A sample is scanned three times from kinetic energy 130 to 730 eV under the above conditions. The intensities of carbon (C) KLL and iron (Fe) LMM peaks are obtained in differential form to give the C/Fe ratio.

The amount of the lubricant in the upper and lower layers is preferably 5 to 30 parts by weight per 100 parts by weight of the hexagonal ferrite powder or the non-magnetic inorganic powder, respectively.

Since the physical actions of these additives vary among individuals, the kind and amount of an additive or the mixing ratio of additives used in combination for producing a synergistic effect should be determined so as to produce optimum results according to the purpose. The following is a few examples of conceivable manipulations using additives. (1) Bleeding of fatty acid additives is suppressed by using fatty acids having different melting points between the magnetic layer and the non-nagnetic layer. (2) Bleeding of ester additives is suppressed by using esters different in boiling point, melting point or polarity between the magnetic layer and the non-magnetic layer. (3) Coating stability is improved by adjusting the amount of a surface active agent. (4) The amount of the lubricant in the intermediate layer is increased to improve the lubricating effect. The total amount of the lubricants to be used in the magnetic or non-magnetic layer is generally selected from a range of 0.1% to 50% by weight, preferably 2% to 25% by weight, based on the hexagonal ferrite powder or non-magnetic inorganic powder, respectively.

All or part of the additives can be added at any stage of preparing the magnetic or non-magnetic coating composition. For example, the additives can be blended with the magnetic powder before kneading, be mixed with the magnetic powder, the binder, and a solvent in the step of kneading, or be added during or after the step of dispersing or immediately before coating. The purpose of using an additive could be achieved by applying a part of, or the whole of, the additive on the magnetic layer surface either by simultaneous coating or successive coating, which depends on the purpose. A lubricant could be applied to the magnetic layer surface even after calendering or slitting, which depends on the purpose.

The thickness of the support is selected from a range of 2 to 100 μm, preferably 2 to 80 μm. In particular, the thickness of the support for computer tapes ranges from 3.0 to 6.5 μm, preferably 3.0 to 6.0 μm, still preferably 4.0 to 5.5 μm.

An undercoating layer for adhesion improvement may be provided between the support (preferably a non-magnetic flexible support) and the non-magnetic layer or the magnetic layer. The undercoating layer usually has a thickness of 0.01 to 0.5 μm, preferably 0.02 to 0.5 μm. Furthermore, a backcoating layer may be provided on the side opposite to the magnetic layer side for static prevention and curling correction. The backcoating layer usually has a thickness of 0.1 to 4 μm, preferably 0.3 to 2 μm. The undercoating layer and the backcoating layer can be of known materials.

The thickness of the magnetic layer in the dual layer structure is 0.05 to 0.5 μm, preferably 0.05 to 0.30 μm, while it is to be optimized according to the saturation magnetization and the gap length of a head used and the wavelength range of recording signals. The thickness of the lower layer is usually 0.2 to 5.0 μm, preferably 0.3 to 3.0 μm, still preferably 1.0 to 2.5 μm. The lower layer manifests its effects as long as it is substantially non-magnetic. The effects of the lower layer will be produced even where it contains a small amount of a magnetic substance, either intentionally or unintentionally. Such a layer structure is understandably construed as being included under the scope of the present invention. The term “substantially non-magnetic” as referred to above means that the lower layer has a residual magnetic flux density of 10 mT or less or a coercive force of 100 Oe (≈8 kA/m) or less. Preferably, the lower layer has neither residual magnetic flux density nor coercive force. The amount of the magnetic powder, if any, in the lower layer is preferably less than a half the weight of the total inorganic powder of the lower layer. The non-magnetic lower layer may be replaced with a soft magnetic layer containing soft magnetic powder and a binder. In that case, the thickness of the soft magnetic layer is the same as that of the non-magnetic lower layer.

Where the magnetic recording medium of the invention has two magnetic layers, a non-magnetic layer or a soft magnetic layer can be or may not be provided. The magnetic layer farther from the support can have a thickness of 0.2 to 2 μm, preferably 0.2 to 1.5 μm, whereas the one closer to the support can have a thickness of 0.8 to 3 μm. Where the magnetic recording medium has a single magnetic layer with no lower layer, the magnetic layer's thickness is usually 0.2 to 5 μm, preferably 0.5 to 3 μm, still preferably 0.5 to 1.5 μm.

The magnetic recording medium may have a backcoating layer as mentioned previously. Magnetic tapes for computer data storage, in particular, are keenly required to have durability against repeated running as compared with video tapes and audio tapes. To maintain such high running durability as demanded, it is preferred for the backcoating layer to contain carbon black and inorganic powder.

It is preferred to use two carbon black species different in average particle size, i.e., fine carbon black particles having an average particle size, e.g., of 10 to 20 nm and coarse carbon black particles having an average particle size, e.g., of 230 to 300 nm, in combination. In general, addition of fine carbon black particles results in low surface resistivity and low light transmission of the backcoating layer. In view of the fact that many magnetic recording systems utilize a transmission of a magnetic tape as an operational signal, addition of fine carbon black particles is specially effective in this kind of systems. Besides, fine carbon black particles are generally excellent in liquid lubricant holding capability and therefore contributory to reduction of the coefficient of friction in cooperation with the lubricant. The coarse carbon black particles, on the other hand, function as a solid lubricant. Further, the coarse particles form micro projections on the backcoating layer surface to reduce the contact area, which contributes to reduction of the frictional coefficient.

Examples of commercially available fine or coarse carbon black particles that can be utilized in the invention are described in WO 98/35345.

In using two kinds of carbon black having different average particle sizes in the backcoating layer, the weight ratio of fine particles (10 to 20 nm) to coarse particles (230 to 300 nm) is preferably 98:2 to 75:25, still preferably 95:5 to 85:15.

The total carbon black content in the backcoating layer usually ranges from 30 to 80 parts by weight, preferably 45 to 65 parts by weight, per 100 parts by weight of the binder.

It is preferred to use two kinds of inorganic powder different in hardness in the backcoating layer. Specifically, it is preferred to use a soft inorganic powder having a Mohs hardness of 3 to 4.5 and a hard inorganic powder having a Mohs hardness of 5 to 9 in combination. Addition of a soft inorganic powder having a Mohs hardness of 3 to 4.5 is effective to stabilize the frictional coefficient in repeated running. Hardness of this level will not grind down the guide poles. The soft inorganic powder preferably has an average particle size of 30 to 50 nm.

The soft inorganic powders having a Mohs hardness of 3 to 4.5 include calcium sulfate, calcium carbonate, calcium silicate, barium sulfate, magnesium carbonate, zinc carbonate, and zinc oxide. They can be used either individually or as a combination of two or more thereof. The content of the soft inorganic powder in the backcoating layer is preferably 10 to 140 parts by weight, still preferably 35 to 100 parts by weight, per 100 parts by weight of carbon black in the backcoating layer.

The hard inorganic powder having a Mohs hardness of 5 to 9 enhances the strength of the backcoating layer and thereby improves the running durability of the recording medium. A combined use of the hard inorganic powder with carbon black and the soft inorganic powder provides a stronger backcoating layer less susceptible to deterioration by repeated sliding. Further, existence of the hard inorganic powder in the backcoating layer produces moderate abrasive properties to reduce adhesion of grinding debris to tape guide poles, etc. When, in particular, used in combination with the soft one, the hard inorganic powder improves sliding properties on guide poles with a rough surface and thereby stabilizes the frictional coefficient of the backcoating layer.

The hard inorganic powder preferably has an average particle size of 80 to 250 nm, particularly 100 to 210 nm.

The hard inorganic powder with a Mohs hardness of 5 to 9 includes α-iron oxide, α-alumina, and chromium oxide (Cr₂O₃). These powders can be used either individually or as a combination. Preferred of them is α-iron oxide or α-alumina. The content of the hard inorganic powder is usually 3 to 30 parts by weight, preferably 3 to 20 parts by weight, per 100 parts by weight of carbon black.

Where the soft inorganic powder and the hard inorganic powder are used in combination, they are preferably selected to have a hardness difference of 2 or greater, still preferably 2.5 or greater, especially preferably 3 or greater.

It is most desirable for the backcoating layer to contain both the two kinds of inorganic powders different in Mohs hardness and the two kinds of carbon black powders different in average particle size.

The backcoating layer may contain lubricants. Lubricants for the backcoating layer can be chosen from those described above for use in the non-magnetic or magnetic layers. The lubricant can be added usually in an amount of 1 to 5 parts by weight per 100 parts by weight of the binder.

The support that can be used in the invention is preferably non-magnetic and flexible. The support preferably has a thermal shrinkage of 0.5% or less at 100° C.×30 minutes and of 0.5% or less, still preferably 0.2% or less, at 80° C.×30 minutes, and is desirably isotropic such that the differences in the above-mentioned thermal shrinkage characteristics in all in-plane directions are within 10%.

Known films, such as polyesters (e.g., polyethylene terephthalate and polyethylene naphthalate), polyolefins, cellulose triacetate, polycarbonate, aliphatic polyamides, aromatic polyamides, polyimide, polyamideimide, polysulfone, polyaramid, and polybenzoxazole, can be used. High strength supports of polyethylene naphthalate or polyamide are preferred. If desired, a laminated support, such as the one disclosed in JP-A-3-224127, can be usedto provide different surface profiles between the magnetic layer side and the back side. The support maybe subjected to surface treatment, such as corona discharge treatment, plasma treatment, treatment for easy adhesion, heat treatment, and dust proof treatment. An alumina or glass support could also be employed.

In order to accomplish the object of the invention, it is necessary to use a support having a three-dimensional mean surface roughness (Sa) of 4.0 nm or smaller, preferably 2.0 nm or smaller, as measured with a three-dimensional profilometer TOPO-3D, supplied by Wyko. It is preferred for the support to have not only a small mean surface roughness but no projections of 0.5 μm or higher. The surface profile is freely controllable as desired by the size and amount of fillers added to the support. Useful fillers include oxides and carbonates of Ca, Si, Ti, etc. and organic fine powders of acrylic resins, etc. The surface profile of the support preferably has a maximum height Sₘₐₓ of 1 μm or smaller, a 10 point average roughness S_{z} of 0.5 μm or smaller, a maximum peak-to-mean plane height Sₚ of 0.5 μm or smaller, a maximum mean plane-to-valley depth Sᵥ of 0.5 μm or smaller, a mean plane area ratio Sr of 10% to 90%, and an average wavelength Sλₐ of 5 to 300 μm. The projection distribution on the support surface can be controlled arbitrarily by the filler to provide desired electromagnetic characteristics and durability. The number of projections of 0.01 to 1 μm per 0.1 mm² is controllable between 0 and 2000.

The support preferably has an F5 value of 5 to 50 kg/mm² (≈49 to 490 Mpa), a thermal shrinkage of 3% or less, still preferably 1.5% or less, at 100° C.×30 minutes and of 1% or less, still preferably 0.5% or less, at 80° C.×30 minutes, a breaking strength of 5 to 100 kg/mm² (≈49 to 980 MPa), and an elastic modulus of 100 to 2000 kg/mm² (≈0.98 to 19.6 GPa). The coefficient of temperature expansion is 10⁻⁴ to 10⁻⁸/° C., preferably 10⁻⁵ to 10⁻⁶/° C., and the coefficient of humidity expansion is 10⁻⁴/RH% or less, preferably 10⁻⁵/RH% or less. It is desirable for the support to be isotropic such that the differences in these thermal, dimensional, and mechanical characteristics in all in-plane directions are within 10%.

Methods of preparing the magnetic and non-magnetic coating compositions include at least the steps of kneading and dispersing and, if desired, the step of mixing which is provided before or after the step of kneading and/or the step of dispersing. Each step may be carried out in two or more divided stages. Any of the materials, including the magnetic powder, non-magnetic powder, binder, carbon black, abrasive, antistatic, lubricant, and solvent, can be added at the beginning of or during any step. Individual materials may be added in divided portions in two or more steps. For example, polyurethane may be added dividedly in the kneading step, the dispersing step, and a mixing step provided for adjusting the viscosity of the dispersion. To accomplish the object of the invention, known techniques for coating composition preparation can be applied as a part of the method. The kneading step is preferably performed using a kneading machine with high kneading power, such as an open kneader, a continuous kneader, a pressure kneader, and an extruder. In using a kneader, the magnetic or non-magnetic powder, part (preferably at least 30% by weight of the total binder) or the whole of the binder, and 15 to 500 parts by weight of a solvent per 100 parts by weight of the magnetic or non-magnetic powder are kneaded. For the details of the kneading operation, reference can be made in JP-A-1-106338 and JP-A-1-79274. In the step of dispersing, glass beads can be used to disperse the magnetic or non-magnetic mixture. Zirconia beads, titania beads or steel beads, which are high-specific-gravity dispersing media, are suitable. The size and mixing ratio of the dispersing medium should be optimized. Known dispersing machines can be used.

The magnetic recording medium which has a dual layer structure is preferably produced by the following wet-on-wet coating methods.
(a) A method comprising forming a lower layer by using a coating apparatus generally employed for a magnetic coating composition, such as a gravure coater, a roll coater, a blade coater or an extrusion coater, and applying a magnetic coating composition while the lower layer is wet by means of an extrusion coating apparatus disclosed in JP-B-1-46186, JP-A-60-238179, and JP-A-2-265672 which is of the type in which a support is pressed while coated.
(b) A method in which the lower layer and the upper layer are applied almost simultaneously through a single coating head disclosed in JP-A-63-88080, JP-A-2-17971, and JP-A-2-265672, the coating head having two slits through which the respective coating liquids pass.
(c) A method in which the lower and the upper layers are applied almost simultaneously by means of an extrusion coating apparatus disclosed in JP-A-2-174965, the apparatus being equipped with a back-up roll.

In order to prevent reduction of electromagnetic characteristics due to agglomeration of magnetic particles, it is advisable to give shear to the coating composition in the coating head. The techniques taught in JP-A-62-95174 and JP-A-1-236968 are suited for shear application. The coating compositions should satisfy the viscosity requirement specified in JP-A-3-8471. A wet-on-dry coating manner in which a magnetic coating composition is applied after the lower layer is dried is also applicable without impairing the effects of the invention. Nevertheless, the above-mentioned wet-on-wet coating systems are recommended to reduce coating defects and thereby to improve qualities, for example, to reduce a dropout rate.

In the case of disk media, although sufficiently isotropic orientation could sometimes be obtained without orientation using an orientation apparatus, it is preferred to use a known random orientation apparatus in which cobalt magnets are obliquely arranged in an alternate manner or an alternating magnetic field is applied with a solenoid. While hexagonal ferrite powder is liable to have 3D random orientation in in-plane directions plus the vertical direction but could have in-plane 2D random orientation. It is also possible to provide a disk with circumferentially isotropic magnetic characteristics by vertical orientation in a known manner, for example, by using facing magnets with their polarities opposite. Vertical orientation is particularly preferred for high-density recording. Circumferential orientation may be achieved by spin coating.

In the production of magnetic tapes, the magnetic powder is oriented in the running direction using cobalt magnets or a solenoid. The orientation apparatus is preferably designed to control the position of drying the coating layer by controlling the temperature and amount of drying air in view of the coating speed. The coating speed is preferably 20 to 1000 m/min, and the drying air temperature is preferably 60° C. or higher. The coating layer may be pre-dried before entering the magnet zone.

After drying, the magnetic recording medium is usually subjected to calendering. Calendering is carried out with metallic rolls or rolls of heat-resistant plastics, such as epoxy resins, polyimide, polyamide and polyimide-amide. Calendering between metallic rolls is preferred in making double-sided magnetic recording media. Calendering is preferably carried out at a temperature of 50° C. or higher, still preferably 100° C. or higher, under a linear pressure of 200 kg/cm (≈196 kN/m) or higher, still preferably 300 kg/cm (≈294 kN/m) or higher.

The magnetic layer of the magnetic recording medium according to the invention preferably has a thickness of 0.01 to 0.5 μm, a Br·δ value (Br: residual magnetic flux density; δ: magnetic layer thickness) of 5 to 200 mT·μm, and a coercive force Hc of 1800 to 5000 Oe (≈143 to 398 kA/m), still preferably 1800 to 3000 Oe (≈143 to 240 kA/m). The narrower the coercive force distribution, the better. The switching field distribution (SFD) and SFDr are preferably 0.6 or smaller.

In the case of disk media, a squareness (SQ) is usually 0.55 to 0.67, preferably 0.58 to 0.64, in two-dimensional random orientation, and preferably 0.45 to 0.55 in three-dimensional random orientation. In vertical orientation, the SQ is usually 0.6 or greater, preferably 0.7 or greater, in the vertical direction. When demagnetization field correction is made, it would be 0.7 or greater, preferably 0.8 or greater. The orientation ratio is preferably 0.8 or higher in both two-dimensional random orientation and three-dimensional random orientation. In the case of two-dimensional random orientation, it is preferred that all the squareness ratio, Br, and Hc in the vertical direction be in the range of 10 to 50% of those in the in-plane directions.

In the case of magnetic tapes, the squareness (SQ) is 0.7 or greater, preferably 0.8 or greater.

The magnetic recording medium of the invention has a frictional coefficient of 0.5 or smaller, preferably 0.3 or smaller, at temperatures of −10° to 40° C. and humidities of 0 to 95%. The surface resistivity on the magnetic surface is preferably 10⁴ to 10¹² Ω/sq. The static potential is preferably −500 to +500 V. The magnetic layer preferably has an elastic modulus at 0.5% elongation of 100 to 2000 kg/mm² (≈980 to 19600 N/mm²) in every in-plane direction and a breaking strength of 10 to 70 kg/mm² (≈98 to 686 N/mm²). The magnetic recording medium preferably has an elastic modulus of 100 to 1500 kg/mm² (≈980 to 14700 N/mm²) in every in-plane direction, a residual elongation of 0.5% or less, and a thermal shrinkage of 1% or less, still preferably 0.5% or less, particularly preferably 0.1% or less, at temperatures of 100° C. or lower. The glass transition temperature (maximum loss elastic modulus in dynamic viscoelasticity measurement at 110 Hz) of the magnetic layer is preferably 50° to 120° C., and that of the lower layer is preferably 0° to 100° C. The loss elastic modulus preferably ranges 1×10³ to 1×10⁴ N/cm². The loss tangent is preferably 0.2 or lower. Too high a loss tangent easily leads to a tack problem. It is desirable that these thermal and mechanical characteristics be substantially equal in all in-plane directions with differences falling within 10%. The residual solvent content in the magnetic layer is preferably 100 mg/m² or less, still preferably 10 mg/m² or less. The upper and the lower layers each preferably have a void of 30% by volume or less, still preferably 20% by volume or less. While a lower void is better for high output, there are cases in which a certain level of void is recommended. For instance, a relatively high void is often preferred for disk media which put weight on durability against repeated use.

With respect to the 3D surface profile of the magnetic layer as measured with TOPO-3D (Wyko), the mean surface roughness Sa is preferably 5.0 nm or less, still preferably 4.0 nm or less, particularly preferably 3.5 nm or less. The 3D surface profile preferably has a maximum height Sₘₐₓ of 0.5 μm or smaller, a 10 point average roughness S_{z} of 0.3 μm or smaller, a maximum mean surface-to-peak height Sₚ of 0.3 μm or smaller, a maximum mean surface-to-valley depth Sᵥ of 0.3 μm or smaller, a mean surface area ratio Sr of 20% to 80%, and an average wavelength λₐ of 5 to 300 μm. It is preferred to optimize the electromagnetic characteristics and the frictional coefficient of the magnetic layer by controlling the surface projection distribution such that the number of projections of 0.01 to 1 μm per mm2 may range from 0 to 2000. Desired magnetic layer's surface profile and surface projection distribution are easily obtained by controlling the surface profile of the support (which can be done by means of a filler as previously mentioned), by adjusting the particle size and amount of powders used in the magnetic layer, and by selecting the surface profile of calendering rolls. Curling of the magnetic recording medium is preferably within ±3 mm. Where the magnetic recording medium has a dual layer structure, it is easily anticipated that the physical properties are varied between the lower and the upper layers according to the purpose. For example, the elastic modulus of the upper layer can be set relatively high to improve running durability, while that of the lower layer can be set relatively low to improve head contact.

### EXAMPLES

The present invention will now be illustrated in greater detail with reference to Examples, but it should be understood that the invention is not construed as being limited thereto. Unless otherwise noted, all the percents and parts are by weight.

### Examples 1 and 2 and Comparative Examples 1 and 2

1) Preparation of Magnetic Coating Compositions

| | |
|---|---|
| Barium ferrite (see Tables 2 and 3) | 100 parts |
| Binder resin | |
| Vinyl chloride copolymer (—SO₃K content: 1 × 10⁻⁴ eq/g; | 12 parts |
| degree of polymerization: 300) | |
| Polyester polyurethane resin (neopentyl | 4 parts |
| glycol/caprolactone | |
| polyol/diphenylmethane-4,4′-diisocyanate | |
| (MDI) = 0.9/2.6/1 (by mole); —SO₃Na content: | |
| 1 × 10⁻⁴ eq/g) | |
| α-Alumina (average particle size: 0.15 μm) | 2 parts |
| Carbon black (see Tables 1 and 3; average primary particle | 5 parts |
| size: 17 nm; S_{BET}: 210 m²/g; DBP oil absorption: | |
| 68 ml/100 g) | |
| Butyl stearate | 2 parts |
| Stearic acid | 3 parts |
| Methyl ethyl ketone | 125 parts |
| Cyclohexanone | 125 parts |

The characteristics of the barium ferrites (BF-1 and BF-2) are shown in Table 2. The water-soluble ion contents in the carbon black (carbon blacks 1 to 4) are shown in Table 1. BF-1 and BF-2 and carbon blacks 1 to 4 were prepared by varying the purity of the raw material and the level of washing with water.

TABLE 1

| Carbon | Water-soluble Cation Content (ppm) | | | | | | Water-soluble Anion Content (ppm) | | | | | | |
|---|---|---|---|---|---|---|---|---|---|---|---|---|---|
| Black No. | Na⁺ | NH₄⁺ | K⁺ | Mg²⁺ | Ca²⁺ | Total | Cl⁻ | NO₂⁻ | Br⁻ | NO₃⁻ | PO₄³⁻ | SO₄²⁻ | Total |
| 1 | 1 | 0 | 48 | 0 | 0 | 49 | 10 | 0 | 0 | 0 | 0 | 54 | 64 |
| 2 | 1 | 2 | 1 | 1 | 0 | 5 | 1 | 0 | 0 | 1 | 0 | 0 | 2 |
| 3 | 188 | 10 | 122 | 7 | 23 | 350 | 7 | 0 | 0 | 3 | 0 | 560 | 570 |
| 4 | 280 | 30 | 271 | 57 | 250 | 888 | 156 | 0 | 0 | 11 | 0 | 1390 | 1557 |

TABLE 2

| | | | | | | | | | | | | | Water-soluble Cation | | | | Iron | |
|---|---|---|---|---|---|---|---|---|---|---|---|---|---|---|---|---|---|---|
| Hex- | | | | | Hc | Water-soluble Anion Content (ppm) | | | | | | | Content (ppm) | | | | com- | |
| agonal | Average | Aspect | S_{EET} | σs | (×10⁵ | | | | | | | Total | | | | Total | plex | |
| ferrite | Length | ratio | (m²/g) | (emu/g) | A/m) | Cl⁻ | NO₂⁻ | NO₃⁻ | Br⁻ | PO₄³⁻ | SO₄²⁻ | anion | Na⁺ | Ca²⁺ | Mg²⁺ | cation | (ppm) | pH |
| BF-1 | 23.5 | 3.7 | 78.0 | 49.3 | 1.80 | 5 | 1 | 0 | 2 | 0 | 3 | 11 | 0 | 1 | 0 | 1 | 7 | 7.9 |
| BF-2 | 24.9 | 3.6 | 67.5 | 48.8 | 1.78 | 10 | 2 | 0 | 2 | 0 | 3 | 17 | 2 | 1 | 0 | 3 | 6 | 7.4 |

The vinyl chloride copolymer and carbon black were kneaded together with half the solvent formulation in a kneader. The rest of the above components were mixed therein, and the mixture was dispersed in a sand grinder. Fourteen parts of polyisocyanate and 30 parts of cyclohexanone were added to the dispersion. The resulting dispersion was filtered through a filter having an average opening size of 1 μm to prepare a magnetic coating composition.

2) Preparation of Non-magnetic Coating Compositions

| | |
|---|---|
| Needle-like hematite (S_{BET}: 55 m²/g; average length: 0.10 μm; | 80 parts |
| average aspect ratio: 7; pH: 8.8; surface treated with 1%, in | |
| terms of Al₂O₃, of alumina) | |
| Carbon black (average primary particle size: 17 nm; | 20 parts |
| S_{BET}: 210 m²/g; DBP oil absorption: 68 ml/100 g) | |
| Binder resin: | |
| Vinyl chloride copolymer (—SO₃K content: 1 × 10⁻⁴ eq/g; | 12 parts |
| degree of polymerization: 300) | |
| Polyester polyurethane resin (neopentyl | 5 parts |
| glycol/caprolactone polyol/MDI = 0.9/2.6/1 (by mole); | |
| —SO₃Na content: 1 × 10⁻⁴ eq/g) | |
| Butyl stearate | 3 parts |
| Stearic acid | 3 parts |
| Methyl ethyl ketone/cyclohexanone (1/1 by volume) | 280 parts |

3) Preparation of Coating Compositions for Backcoating Layer

| | |
|---|---|
| Fine particulate carbon black powder (average particle size: | 100 parts |
| 38 nm) | |
| Coarse particulate carbon black powder (average particle size: | 5 parts |
| 80 nm) | |
| Nitrocellulose resin | 67 parts |
| Polyurethane resin | 47 parts |
| Polyisocyanate | 25 parts |
| Methyl ethyl ketone | 1330 parts |
| Cyclohexanone | 420 parts |

After the fine particulate carbon black powder, the coarse particulate carbon black powder, and 50% of the formulation quantity of the polyurethane resin were blended with 300 parts of methyl ethyl ketone and 200 parts of cyclohexanone, the mixture was dispersed by means of a sandmill (dispersion media: zirconia balls with 0.5 mm φ).

Then, after the addition of 50% of the formulation quantity of the polyurethane resin and 130 parts of methyl ethyl ketone, the mixture was dispersed by means of a sand mill (dispersion media: zirconia balls with 0.5 mm φ). To the resultant dispersion, the nitrocellulose resin and 200 parts of methyl ethyl ketone were added. Thereafter, further the polyisocyanate and 700 parts of methyl ethyl ketone and 220 parts of cyclohexanone were added, and the mixture was dispersed by means of a sand mill (dispersion media: zirconia balls with 0.5 mm φ). By filtering the resultant dispersion through a filter with an average pore size of 1 μm, a coating composition for the backcoating layer was prepared.

The vinyl chloride copolymer and carbon black were kneaded together with half of the mixed solvent (methyl ethyl ketone/cyclohexanone) in a kneader. The rest of the above components were mixed therein, and the mixture was dispersed in a sand grinder. Fifteen parts of polyisocyanate and 30 parts of cyclohexanone were added thereto. The resulting dispersion was filtered through a filter having an average opening size of 1 μm to prepare a non-magnetic coating composition.

4) Preparation of Magnetic Tape

The non-magnetic coating composition was applied to a 7 μm thick polyethylene terephthalate base film to a dry thickness of 1.5 μm. Immediately thereafter, the magnetic coating composition was applied thereon to give the dry coating thickness shown in Table 3 while the lower non-magnetic coating was wet. While the lower and upper coatings were wet, the film was passed through a rare earth magnet (surface magnetic flux density: 500 mT) and then a solenoid magnet (magnetic flux density: 500 mT) for longitudinal orientation. While passing through the solenoid, the coating layers were dried to such an extent that the magnetic powder might not be deoriented. The coated film was further dried in a drying zone and wound. The coated film was passed through a 7-roll calender composed of metal rolls at a roll temperature of 90° C. After that, the coating composition for the backcoating layer is coated and dried to form a backcoating layer having a thickness of 0.5 μm to obtain a magnetic recording medium in web form, which was slit into 8 mm wide video tapes.

5) Evaluation

The resulting magnetic tape was evaluated for electromagnetic characteristics, magnetic characteristics, surface roughness, and storage stability in accordance with the following methods. The results obtained are shown in Table 3.

5-1) Electromagnetic Characteristics (Output and C/N)

The magnetic tape was run on an 8 mm deck for data recording equipped with an MIG head (headgap: 0.2 μm; track width: 17 μm; saturation magnetic flux density: 1.5 T; azimuth angle: 20°) and an MR head for reading (SAL bias; MR element: Fe—Ni; track width: 6 μm; gap length: 0.2 μm; azimuth angle: 20°). An optimum recording current was decided from the input/output characteristics in recording 1/2 Tb (λ=0.5 μm) signals at a relative tape running speed of 10.2 m/sec (with respect to the MIG head). Signals were recorded at the optimum current with the MIS head and reproduced with the MR head. The C/N was defined to be a ratio covering from reproduced carrier peak to demagnetization noise. The resolution band width of the spectral analyzer was set at 100 kHz. The output and the C/N were relatively expressed taking the results of Comparative Example 1 as a standard.

5-2) Surface Roughness

The surface profile of a 250 μm side square of a sample was measured with a three-dimensional profilometer TOPO-3D, supplied by Wyko. In computing the measured values, corrections, such as tilt correction, spherical correction and cylindrical correction, were made in accordance with JIS B601. The mean surface roughness Sa was taken as a measure of surface roughness.

5-3) Magnetic Characteristics

Magnetic characteristics were measured in parallel with the orientation direction with a vibrating sample magnetometer (manufactured by Toei Industry Co., Ltd.) in an applied magnetic field of 400 kA/m.

To evaluate storage stability, the magnetic tape was stored at 60° C. and 90% RH for one week, and changes in coefficient of friction and formation of surface precipitates were observed as follows.

5-4) Frictional Coefficient

Before and after the storage, the tape was slid 1 to 100 passes on a SUS 420J cylinder having a diameter of 4 mm at a wrap angle of 180° under a load of 10 g at a speed of 14 mm/s. The sliding resistance (T2; unit: g) was measured in the first pass and the hundredth pass to calculate the respective coefficients of friction (μ) according to the following Euler's formula:
μ=(1/π)ln(T2/10)
5-5) Surface Precipitate

The surface (i.e., magnetic layer surface) of the tape after the storage was observed under an optical microscope and a scanning electron microscope to see if any precipitate had been formed.

TABLE 3

| | | | Magnetic Characteristics | | | | | | | | | | | |
|---|---|---|---|---|---|---|---|---|---|---|---|---|---|---|
| | | | | | Magnetic | | | Frictional Coefficient μ | | | | | | |
| | | | Hc | | Layer | | Surface | Before | | After | | | | |
| | Hexa- | Carbon | (×10⁵ | | Thickness | Br · δ | Roughness | Storage | | Storage | | Surface | Output | |
| | ferrite | Black | A/m) | SQ | δ (μm) | (mT · μm) | (Sa) | 1 P | 100 P | 1 P | 100 P | Precipitate | (dB) | (dB) |
| Ex. 1 | BF-1 | 1 | 1.84 | 0.60 | 0.16 | 12.9 | 2.5 | 0.26 | 0.28 | 0.32 | 0.27 | none | 0.3 | 0.3 |
| Ex. 2 | BF-2 | 2 | 1.83 | 0.58 | 0.15 | 13.3 | 2.4 | 0.25 | 0.28 | 0.33 | 0.27 | none | 0.2 | 0.1 |
| Comp. | BF-1 | 3 | 1.83 | 0.58 | 0.16 | 12.9 | 2.7 | 0.26 | 0.28 | 0.34 | 0.43 | much | 0.0 | 0.0 |
| Ex. 1 | | | | | | | | | | | | | | |
| Comp. | BF-2 | 4 | 1.83 | 0.59 | 0.15 | 13.3 | 2.5 | 0.27 | 0.29 | 0.37 | 0.51 | slight | −0.2 | −0.3 |
| Ex. 2 | | | | | | | | | | | | | | |

This application is based on Japanese Patent application JP 2003-278531, filed Jul. 23, 2003, the entire content of which is hereby incorporated by reference, the same as if set forth at length.

1. A magnetic recording medium comprising a support and a magnetic layer containing a hexagonal ferrite powder and carbon black, the carbon black having a total content of Na⁺, K⁺, Mg²⁺, Ca²⁺, and NH₄⁺ of 0 to 100 ppm and a total content of Cl⁻, No₂⁻, NO₃⁻, SO₄²⁻, and PO₄³⁻ of 0 to 100 ppm.

2. The magnetic recording medium according to claim 1, wherein the hexagonal ferrite powder has a total content of Na⁺, K⁺, Mg²⁺, Ca²⁺, and NH₄₊ of 0 to 100 ppm and a total content of Cl⁻, No₂⁻, NO₃⁻, SO₄²⁻, and PO₄³⁻ of 0 to 100 ppm.

3. The magnetic recording medium according to claim 1, wherein the carbon black has an average particle size of 5 to 300 nm.

4. The magnetic recording medium according to claim 1, further comprising a lower layer containing non-magnetic inorganic powder and a binder, so that the support, the lower layer and the magnetic layer are in this order.

5. The magnetic recording medium according to claim 4, wherein the non-magnetic inorganic powder is at least one of titanium dioxide, zinc oxide, iron oxide, and barium sulfate.

6. The magnetic recording medium according to claim 4, wherein the non-magnetic inorganic powder is at least one of titanium dioxide and alpha iron oxide.

7. The magnetic recording medium according to claim 4, wherein the non-magnetic inorganic powder has an average particle size of 0.005 to 2 μm.

8. The magnetic recording medium according to claim 4, wherein the non-magnetic inorganic powder has an average particle size of 0.01 to 0.2 μm.

9. The magnetic recording medium according to claim 4, wherein the lower layer further contains carbon black.

10. The magnetic recording medium according to claim 1, wherein a surface of the magnetic layer has a C/Fe peak ratio of 5 to 100 as analyzed by Auger electron spectroscopy.

11. The magnetic recording medium according to claim 1, wherein a surface of the magnetic layer has a C/Fe peak ratio of 5 to 80 as analyzed by Auger electron spectroscopy.

12. The magnetic recording medium according to claim 1, wherein the magnetic layer has a thickness of 0.01 to 0.5 μm.

13. The magnetic recording medium according to claim 1, wherein the magnetic layer has a coercive force of 143 to 398 kA/m.

14. The magnetic recording medium according to claim 1, further comprising a backcoating layer containing carbon black and inorganic powder, so that the backcoating layer, the support and the magnetic layer are in this order.

15. The magnetic recording medium according to claim 14, wherein the backcoating layer contains carbon black having an average particle size of 10 to 20 nm and carbon black having an average particle size of 230 to 300 nm.
